(19) United States
(12) Patent Application Publication
(10) Pub. No.: US 2026/0277278 A1
(43) Pub. Date: Sep. 17, 2026

(54) FILAMENT CUT ACCESS PANEL WITH CONCEALED SEAM LIVING HINGE

(71) Applicant: Microsoft Technology Licensing, LLC, Redmond, WA (US)

(72) Inventors: Melvine Axel N’DOUMI, Woodinville, WA (US); Keegan JOHN TRESTER, Mukilteo, WI (US); Michael Gordon OLDANI, Redmond, WA (US); Christopher Alan SCHAFER, Sammamish, WA (US); Paul Ryan SANDOVAL, Redmond, WA (US); Michael Thomas SCOTT-WALSH, Carnation, WA (US)

(21) Appl. No.: 19/077,814

(22) Filed: Mar. 12, 2025

(51) Int. Cl. G06F 1/16

(52) U.S. Cl. CPC G06F 1/1681; G06F 1/1629; G06F 1/1656

(57) ABSTRACT

The disclosed filament cut access panel allows for removal of a concealed access panel on a chassis for a computing device. A filament is placed under the textile covering for the computing device at the time of manufacture. A free end of the filament is pulled to cut the textile covering and allow removal of the access panel so components internal to the device are accessible for repair or replacement. When the filament is pulled to create the access line, a pre-scoring on an underside of the textile covering guides movement of the filament so that the textile covering is cut along a specific path corresponding to a seam between the access panel and the chassis. The access panel may be hinged to the chassis using a living hinge. The living hinge permits relative rotation of the access panel without requiring a visible seam on an exterior surface.

### BACKGROUND

Computing devices encompass a variety of devices that can be programmed to carry out one or more specific sets of arithmetic and/or logical operations, with or without user input. For service and repair, some computing devices have access panels that are intended to be selectively opened by authorized personnel to repair or replace components internal to the computing device.

### SUMMARY

Implementations described and claimed herein provide a computing device comprising a device chassis containing a device component, an access panel nested within a panel cavity of the device chassis, a textile covering adhered to the device chassis and the access panel and overlying a seam between the device chassis and the access panel, and a filament nested beneath the textile covering at the seam between the device chassis and the access panel. The filament extends around a perimeter of the access panel. The filament includes a free end to be pulled away from the seam to cut an access line in the textile covering around the perimeter of the access panel. The access line permits the access panel to be lifted out of the panel cavity and away from the device chassis to access the device component.

Implementations described and claimed herein further provide a method of using a filament cut access panel to gain access to a device component within a computing device. The method comprises displacing a free end of a filament nested beneath a textile covering, pulling the free end of the filament away from the seam to cut an access line in the textile covering around the perimeter of the access panel, and lifting the access panel out of the panel cavity and away from the device chassis to access the device component.

Other implementations are also described and recited herein. This Summary is provided to introduce a selection of concepts in a simplified form that are further described below in the Detailed Descriptions. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a bottom perspective view of an example detachable keyboard having an opened filament cut access panel.

FIG. 2A illustrates a bottom perspective view of an example detachable keyboard having a filament cut hinged access panel in a pre-cut state.

FIG. 2B illustrates a bottom perspective view of an example detachable keyboard having a filament cut fully separable access panel in a pre-cut state.

FIG. 3A illustrates a bottom perspective view of an example detachable keyboard having a filament cut hinged access panel closed and secured in a post-cut state.

FIG. 3B illustrates a bottom perspective view of an example detachable keyboard having a filament cut fully separable access panel closed and secured in a post-cut state.

FIG. 4 illustrates a partial sectional view of an example detachable keyboard having a filament cut hinged access panel in a pre-cut state.

FIG. 5A illustrates a partial sectional view of an example detachable keyboard, specifically of a concealed seam living hinge for the hinged access panel in an unfolded state.

FIG. 5B illustrates a partial sectional view of the example detachable keyboard of FIG. 5A, specifically of the concealed seam living hinge in a partially folded state.

FIG. 6 illustrates a partial sectional view of the example detachable keyboard of FIG. 5A, specifically of the concealed seam living hinge in a folded over state.

FIG. 7 illustrates example operations for using a filament cut access panel to gain access to an interior of a computing device for device component repair or replacement.

### DETAILED DESCRIPTION

Access panels for computing devices are typically both visible to a user in the form of visible seams between the access panel and the surrounding device chassis, and in some implementations, fasteners for securing the access panel in place. Prior attempts to fully conceal an access panel yield usability problems in that the device chassis may need to be cut to create a seam for removing the access panel and concealed fasteners may be difficult to access and use. Thus, accessing concealed access panels may require specialized tools and/or expertise, and may yield a result that is not readily re-secured to the device chassis following a component repair or replacement.

The foregoing issues are magnified for textile-covered keyboards or other computing devices, as the textile's aesthetic and structural integrity is more easily damaged or compromised than solid materials. Conventional textile-covered computing devices often include reveal lines or seams for access panels, which is not desirable from a cosmetic perspective. Further, traditional methods for repairing conventional textile-covered computing devices often require blade-cutting and/or disassembling surrounding parts to remove the access panel, which can leave visible damage to the access panel and/or surrounding device chassis. This may yield aesthetic and structural integrity issues with a repaired computing device. In some cases, the conventional access panel is intended to be replaced rather than re-secured to the device, which is not desirable from a sustainability perspective.

The presently disclosed technology fully or nearly fully conceals an access panel within an un-repaired textile-covered computing device, while providing a mechanism to allow a user to remove the access panel when service or repair of components inside the computing device is required. This access may be achieved without specialized tools or expertise, and with minimal damage to the computing device and visible evidence post-repair. A hidden filament, integrated under the textile, is used to cut a seam in the textile corresponding to a seam between the device chassis and the access panel characterized by a clean, controlled tear along a predefined path. The user can then open the access panel by lifting or pivoting it away from the device chassis. After device component replacements or repairs are made, the textile-covered access panel can be reattached to the device chassis using a secondary fastener (e.g., magnets, adhesives, or snaps). This restores the exterior of the computing device nearly to its original, seamless appearance without obvious visible signs of tampering excepting a subtle residual cut line created by the filament.

The presently disclosed technology provides a mechanical structure that allows for effective, efficient, and cosmetically advantageous removal of an access panel in a computing device and replacement of the access panel following a repair or replacement of a device component therein. The mechanical structure includes a filament nested under a textile-covered area of the computing device containing the access panel. A free end of the filament can be pulled to create a cut in the textile corresponding to a seam between the device chassis and the access panel that allows for removal of the access panel so that the device is accessible for component repairs or replacements. In various implementations, a line may be partially cut through a thickness of the textile on an underside of the textile. This cut is referred to herein as scoring the textile. When the filament is pulled to create the cut, the scoring of the textile may guide movement of the filament so that the cut in the textile is created along the specific predefined path corresponding to the seam between the device chassis and the access panel.

In a pre-repaired state, the presently disclosed technology may also be advantageous over conventional textile-covered computing devices in that the access panel is nearly or completely concealed, reducing the likelihood of accidental ingress into the computing device or detachment of the access panel from the computing device. Further, as most computing devices according to the presently disclosed technology are expected to render their usable service life without requiring access via the access panel, most of the computing devices will never require use of the filament to cut the access line. Therefore, most of the computing devices according to the presently disclosed technology can render their service life to their respective users with the user being unaware of the existence of the access panel. This is an improvement in user experience over devices with readily visible access panels, even if the access panel is never used.

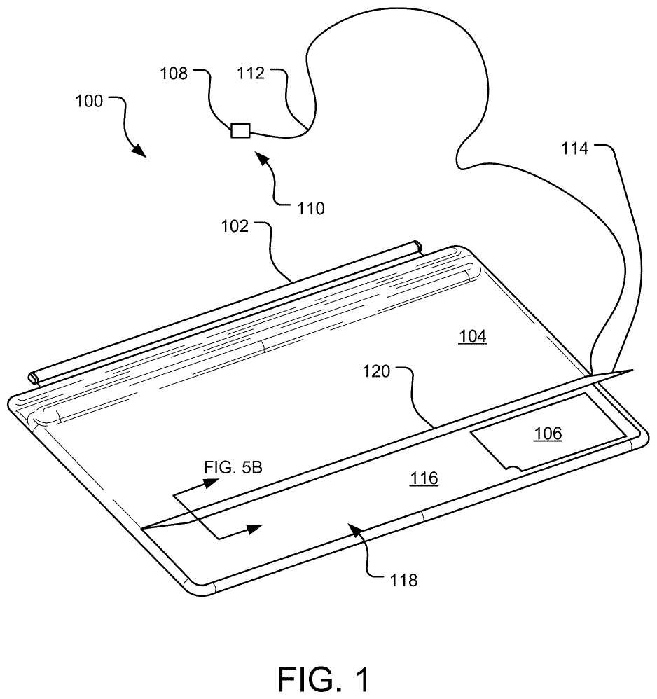

FIG. 1 illustrates a bottom perspective view of an example detachable keyboard 100 having an opened filament cut access panel 114. A hinge 102 pivotally connects a tablet, display, or other device component (not shown) to the keyboard 100. Further, the device component may be selectively separable from the keyboard 100, as shown. The detachable keyboard 100 is depicted as such, however, the filament cut access panel 114 may be similarly incorporated within a variety of computing devices, including mobile computing devices and desktop computing devices.

The keyboard 100 is covered with a textile covering 104 on the entirety of the depicted rear surface of the keyboard 100. The textile covering 104 is adhered to the keyboard 100, specifically device chassis 116 and the access panel 114 and may be laminated at the edges of the keyboard 100 to itself or another textile covering (not shown) covering a portion of the non-depicted front surface of the keyboard 100. In some implementations the textile covering 104 may also extend over the edges of the keyboard 100 to the front surface of the keyboard 100. In other implementations, the textile covering may only cover less than the entirety of the depicted rear surface of the keyboard 100, but at least the access panel 114 and an area surrounding the access panel 114.

The access panel 114 may be of any sufficiently rigid and durable material for the depth specification of its panel cavity 118, discussed below. Example materials include plastics, metal alloys, and carbon fiber. The textile covering 104 may be of any suitably durable and flexible textile, including various fabrics. The textile covering 104 may be of a natural or synthetic construction and woven, knitted, or bonded. An example material for the textile covering 104 is Alacantra, or other synthetic textile with a soft, suede-like microfiber pile.

The device chassis 116 serves as structure for the keyboard 100 and creates surfaces for mounting device components (e.g., battery 106) contained within the keyboard 100. The device components may include a variety of components internal to the keyboard 100 that may require repair or replacement throughout the useable life of the keyboard 100, such as the battery 106, printed circuit boards (PCBs), processing units, memory, data storage devices, keyboard mechanical components (e.g., keys), touchpads, and so on. While repair or replacement of the battery 106 is described with particularity herein, repair or replacement of any other device component accessible via the access panel 114 may be considered similar and is specifically contemplated herein.

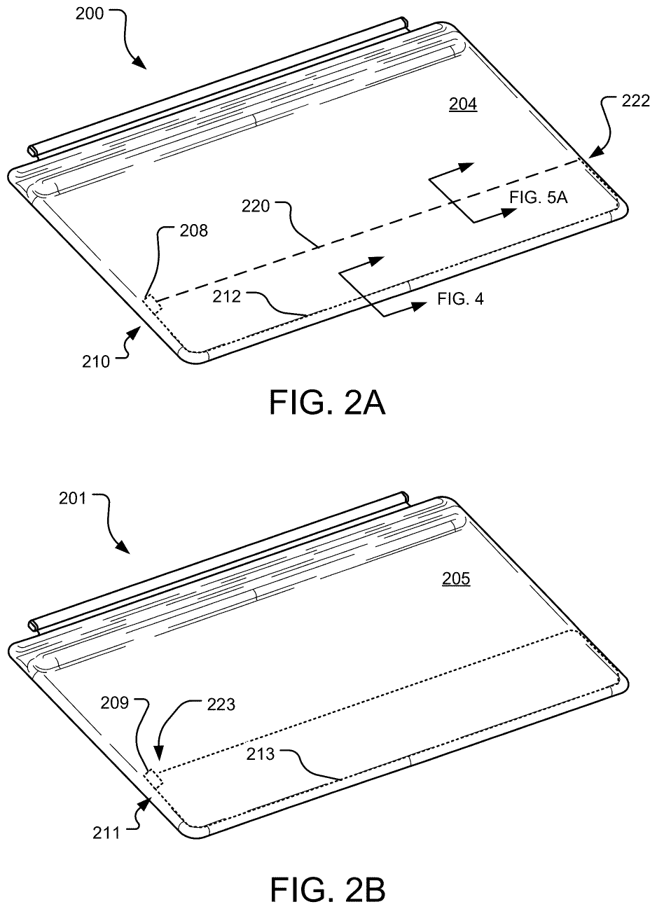

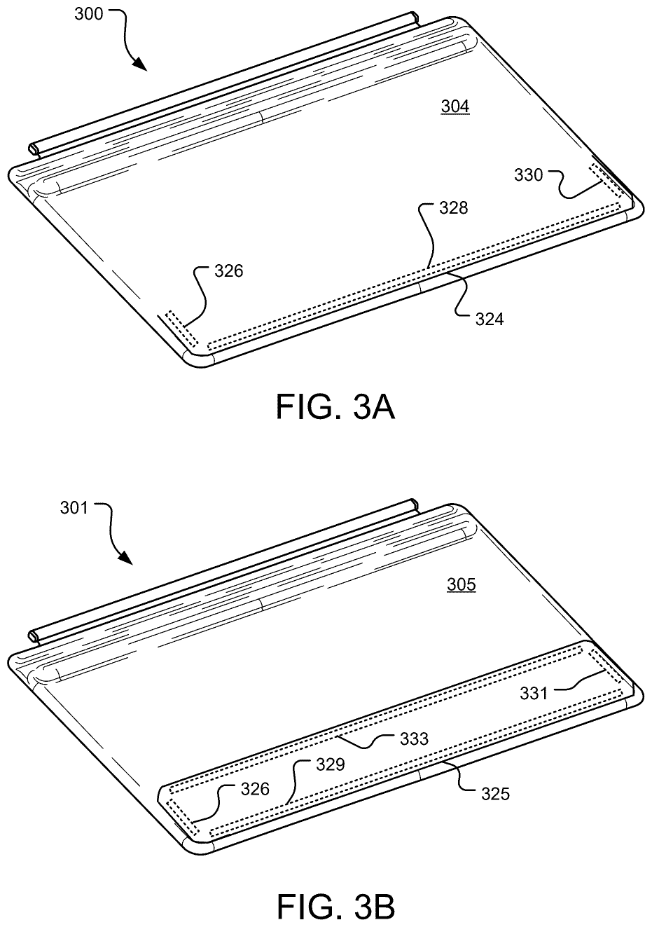

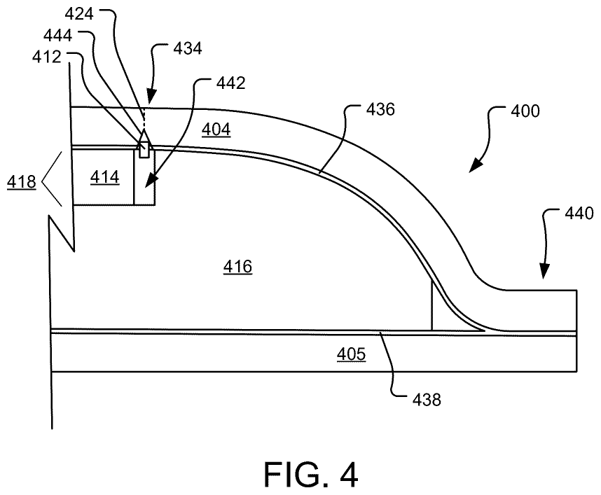

The access panel 114 is shown closed and secured in its pre-cut state in FIG. 2A, which is discussed in detail below. The access panel 114 is released from its nested position (see also FIG. 4, for example) within a panel cavity 118 of the device chassis 116 by pull tab 108 attached to free end 110 of filament 112 out of and away from the device chassis 116. This action cuts an access line (not shown, see e.g., access line 324 of FIG. 3A) in the textile covering 104 around a perimeter of the access panel 114. The access line permits the access panel 114 to be lifted out of the panel cavity 118 and away from the device chassis 116 to access the battery 106, as shown in FIG. 1.

The filament 112 is any extended flexible structure with a sufficient tensile strength and relatively small cross-sectional diameter. The filament 112 may be a spun, or solid structure, and have a metal alloy, natural fiber, or synthetic construction (e.g., steel, cotton, or nylon), as examples. The filament 112 may further be a string, such as a spun yarn type string, any other single or multi-ply string, or a sheath and core type of string. The filament 112 is designed for a maximum gauge to meet pull strength requirements for the selected material and construction. More specifically, the filament 112 may be of a synthetic polymer such as nylon, polyethylene, elastane, polyester, or polyvinylidene fluoride and may come in monofilament or braided (multifilament) form. An example range of gauge for a synthetic polymer filament 112 is 50 to 20.

The pull tab 108 may be separate structure attached to the free end 110 of filament 112, a shown, or simply a loop of the free end 110 the filament 112 to serve as the pull tab 108. The pull tab 108 could be of metal, synthetic polymer, or even cellulose construction. The pull tab 108 may be of any size and shape adequate for a user to locate under the textile covering 104, manually remove from under the textile covering 104, and manipulate to pull the filament 112 away from the device chassis 116.

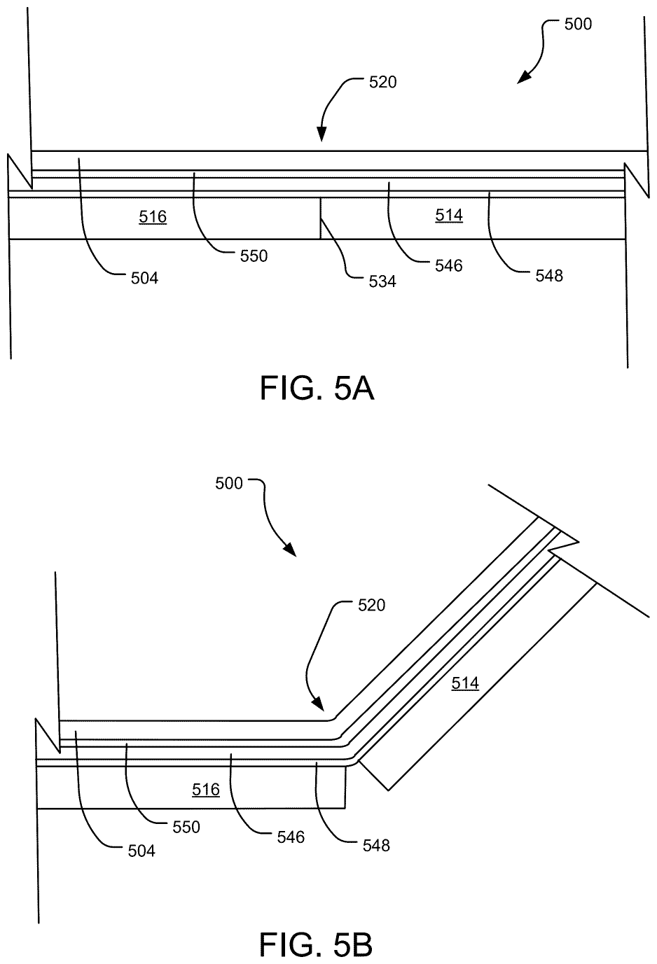

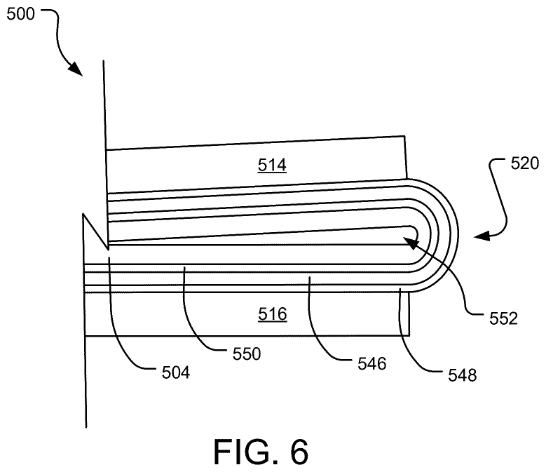

The access line extends only partially around the access panel 114 (a partial perimeter), leaving a remaining perimeter of the access panel connected to the device chassis 116 with a linear living hinge 120. An example of the living hinge 120 is shown in cross-section in FIGS. 5A, 5B, and 6 in unfolded, partially folded, and folded over states, respectively. The partially folded state of the living hinge 120 is similar to that of living hinge 520 of FIG. 5B. The access panel 114 is pivoted out of the panel cavity 118 and away from the device chassis 116 at the living hinge 120 to access the battery 106.

In other implementations, the access line extends around an entire perimeter of the access panel 114, leaving no remainder connected to the device chassis 116. Thus, the living hinge 120 is omitted and the access panel 114 may be lifted entirely out of the panel cavity 118 and separated from the device chassis 116 to access the battery 106. Following a repair or replacement of the battery 106, the access panel 114 may be closed and secured in a post-cut state using secondary fasteners (not shown see e.g., double-sided tape strips 326, 328, 330 of FIG. 3A).

The battery 106 is depicted in FIG. 1 as mounted to the device chassis 116 and the battery 106 is removed from the device chassis 116 for repair or replacement. In an alternative implementation, the battery 106 is mounted to an underside of the access panel 114 and is removed from the access panel 114 for repair or replacement. Further, in implementations where the access panel 114 is separated from the device chassis 116, the access panel 114 and battery 106 may be replaced together as a unit. The implementations of the foregoing may depend on packaging constraints of the keyboard 100, as well as whether replacement of the access panel 114 along with the battery 106 is desired.

The access panel 114 and its associated device chassis 116 are depicted in FIG. 1 as spanning most of a width of the keyboard 100 and approximately ⅓ of a depth of the keyboard 100. This is merely as example as the access panel 114 and its associated device chassis 116 could span any area of the depicted rear surface of the keyboard 100, including up to nearly an entire rear-facing area of the keyboard 100. In other implementations, an access panel similar to the access panel 114 may be placed on the non-depicted front facing surface of the keyboard 100 in addition to or in lieu of the access panel 114. The implementations of the foregoing may depend on packaging constraints of the keyboard 100, including placement of the battery 106 and other device components therein to be made accessible using the access panel 114.

FIG. 2A illustrates a bottom perspective view of an example detachable keyboard 200 having a filament cut hinged access panel (not shown, see e.g., access panel 114 of FIG. 1) in a pre-cut state. The keyboard 200 is covered with a textile covering 204 on the entirety of the depicted rear surface of the keyboard 200, or at least the access panel and an area surrounding the access panel.

A device chassis (not shown, see e.g., device chassis 116 of FIG. 1) serves as a structure for the keyboard 200 and creates surfaces for mounting device components (not shown, see e.g., battery 106 of FIG. 1) within the keyboard 200. The device components include a variety of components internal to the keyboard 200 that may require repair or replacement throughout the useable life of the keyboard 200.

The access panel is shown closed and secured in its pre-cut state and is fully obscured from view. A filament 212 is nested beneath the textile covering 204 at a seam between the device chassis and the access panel. The filament 212 extends around a perimeter of the access panel and includes at least one free end 210 with an attached pull tab 208. As the filament 212 and the pull tab 208 are concealed beneath the textile covering 204, the filament 212 and the pull tab 208 are rendered in dotted lines in FIG. 2A. The concealed filament 212 and pull tab 208 are technically advantageous over conventional solutions in that the access panel and mechanism for accessing the access panel are nearly or entirely concealed from the user in the pre-cut state, yielding a seamless keyboard 200 back surface.

An opposing end 222 of the filament 212 may remain fixed to the device chassis (e.g., tied, pinched, or adhered in place) or free to separate from the device chassis when the filament 212 is pulled out of and away from the device chassis. Other implementations may include a second free end with corresponding pull tab at the opposing end 222 so that the filament 212 may be pulled out of and away from the device chassis from either end. A singular free end of the filament 212 may be technically advantageous in that it may be easier to manufacture and the fixed end allows the filament 212 to remain attached to the device chassis even after use. Dual free ends of the filament 212 may be technically advantageous in that they provide additional flexibility in access to and use of the filament 212.

To access the pull tab 208 and attached filament 212, a user picks the pull tab 208 from beneath the textile covering 204. This may require making a small cut in the textile covering 204 to access the pull tab 208 and/or use of a small tool to pry the textile covering 204 up and pull the pull tab 208 from beneath the textile covering 204. Once the pull tab 208 is accessed, the user can use it as a handle to pull the filament from the keyboard 200.

The access panel is released from its nested position within a panel cavity (also not shown, see e.g., panel cavity 118 of FIG. 1) of the device chassis by pulling the filament 212 out of and away from the device chassis. This action cuts an access line (not shown, see e.g., access line 324 of FIG. 3A) in the textile covering 204 around a perimeter of the access panel. The access line permits the access panel to be lifted out of the panel cavity and away from the device chassis to access the device component(s) for repair or replacement.

The access line extends only partially around the access panel, leaving a remaining perimeter of the access panel connected to the device chassis with a living hinge 220, which is illustrated by dashed lines as it is not visible in FIG. 2A. An example of the living hinge 220 is shown in cross-section in FIGS. 5A, 5B, and 6 in unfolded, partially folded, and folded over states, respectively. The unfolded state of the living hinge is similar to that of living hinge 520 of FIG. 5A. The access panel is pivoted out of the panel cavity and away from the device chassis at the living hinge 220 to access the device component(s) for repair or replacement. A partial sectional view of the keyboard 200, specifically of a seam between the device chassis and the access panel, is illustrated in FIG. 4 and discussed in detail below.

The implementation of FIG. 2A may be technically advantageous over the implementation of FIG. 2B (discussed below) in that the access panel remains attached to the keyboard 200 and cannot be misplaced. Further, following a repair or replacement of the device component(s), the access panel may be closed and secured in a post-cut state without a realignment step as the living hinge 220 maintains the correction positioning of the access panel with reference to the device chassis.

FIG. 2B illustrates a bottom perspective view of an example detachable keyboard 201 having a filament cut fully separable access panel (not shown, see e.g., access panel 114 of FIG. 1) in a pre-cut state. The keyboard 200 is covered with a textile covering 205 on the entirety of the depicted rear surface of the keyboard 201, or at least the access panel and an area surrounding the access panel. A device chassis (not shown, see e.g., device chassis 116 of FIG. 1) serves as a structure for the keyboard 201 and creates surfaces for mounting device components (not shown, see e.g., battery 106 of FIG. 1) within the keyboard 201.

The access panel is shown closed and secured in its pre-cut state and is fully obscured from view. A filament 213 is nested beneath the textile covering 205 at a seam between the device chassis and the access panel. The filament 213 extends around a perimeter of the access panel and includes at least one free end 211 with an attached pull tab 209. As the filament 213 and the pull tab 209 are concealed beneath the textile covering 205, the filament 213 and the pull tab 209 are rendered in dotted lines in FIG. 2B. An opposing end 223 of the filament 213 may remain fixed to the device chassis or free to separate from the device chassis when the filament 213 is pulled out of and away from the device chassis.

To access the pull tab 209 and attached filament 213, a user picks the pull tab 209 from beneath the textile covering 205. This may require making a small cut in the textile covering 205 to access the pull tab 209 and/or use of a small tool to pry the textile covering 205 up and pull the pull tab 209 from beneath the textile covering 205. Once the pull tab 209 is accessed, the user can use it as a handle to pull the filament from the keyboard 201.

The access panel is released from its nested position within a panel cavity (also not shown, see e.g., panel cavity 118 of FIG. 1) of the device chassis by pulling the filament 213 out of and away from the device chassis. This action cuts an access line (not shown, see e.g., access line 325 of FIG. 3B) in the textile covering 205 around a perimeter of the access panel. The access line permits the access panel to be lifted out of the panel cavity and away from the device chassis to access the device component(s) for repair or replacement.

The access line extends around an entire perimeter of the access panel, leaving no remainder connected to the device chassis. Thus, the living hinge 220 of FIG. 2A is omitted from FIG. 2B and the access panel may be lifted entirely out of the panel cavity and separated from the device chassis to access the device component(s) for repair or replacement. The implementation of FIG. 2B may be technically advantageous over the implementation of FIG. 2A (discussed above) in that the access panel can be completely replaced along with the device component(s), if desired. Further, access to the device component(s) may be improved with the access panel completely removed.

FIG. 3A illustrates a bottom perspective view of an example detachable keyboard 300 having a filament cut hinged access panel (not shown, see e.g., access panel 114 of FIG. 1) closed and secured in a post-cut state. The keyboard 300 is covered with a textile covering 304 on the entirety of the depicted rear surface of the keyboard 300, or at least the access panel and an area surrounding the access panel. A device chassis (not shown, see e.g., device chassis 116 of FIG. 1) serves as a structure for the keyboard 300 and creates surfaces for mounting device components (not shown, see e.g., battery 106 of FIG. 1) within the keyboard 300.

The access panel is shown closed and secured in its post-cut state and is fully obscured from view. A filament (not shown, see e.g., filament 212 of FIG. 2A) is nested beneath the textile covering 304 at a seam between the device chassis and the access panel. The filament extends around a perimeter of the access panel and includes at least one free end (not shown, see e.g., free end 210 of FIG. 2A) with an attached pull tab (not shown, see e.g., pull tab 208 of FIG. 2A).

The access panel is released from its nested position within a panel cavity (also not shown, see e.g., panel cavity 118 of FIG. 1) of the device chassis by pulling the filament out of and away from the device chassis. This action cuts an access line 324 in the textile covering 304 around a perimeter of the access panel. The access line 324 permits the access panel to be lifted out of the panel cavity and away from the device chassis to access the device component(s) for repair or replacement.

The access line 324 extends only partially around the access panel, leaving a remaining perimeter of the access panel connected to the device chassis with a living hinge (not shown, see e.g., living hinge 220 of FIG. 2A). Thus, the access panel is pivoted out of the panel cavity and away from the device chassis at the living hinge to access the device component(s) for repair or replacement.

Following a repair or replacement of the device component(s), the access panel may be closed and secured in the post-cut state using secondary fasteners, such as double-sided tape strips 326, 328, 330. Other secondary fasteners include magnets, other adhesives, or snaps that may be used similarly to secure the access panel in the post-cut state. Should the filament and its associated pull tab remain attached to the keyboard 300 after the access line 324 is cut, the filament and its associated pull tab may be tucked into the panel cavity prior to closing and securing the access panel in the post-cut state.

While the access line 324 remains present and potentially visible in the post-cut state, it may be partially obscured by the clean cut provided by the scoring of the underside of the textile covering 304 (discussed below) and an obscuring pattern applied to the textile covering 304. The keyboard 300 is mostly restored to its original, seamless appearance with minimal visible signs of the repair or replacement of the device component(s) and without requiring replacement parts or additional adhesives to re-secure the access panel in the post-cut state.

FIG. 3B illustrates a bottom perspective view of an example detachable keyboard 301 having a filament cut fully separable access panel closed and secured in a post-cut state. The keyboard 301 is covered with a textile covering 305 on the entirety of the depicted rear surface of the keyboard 301, or at least the access panel and an area surrounding the access panel. A device chassis (not shown, see e.g., device chassis 116 of FIG. 1) serves as a structure for the keyboard 301 and creates surfaces for mounting device components (not shown, see e.g., battery 106 of FIG. 1) within the keyboard 301.

The access panel is shown closed and secured in its post-cut state and is fully obscured from view. A filament (not shown, see e.g., filament 212 of FIG. 2A) is nested beneath the textile covering 305 at a seam between the device chassis and the access panel. The filament extends around a perimeter of the access panel and includes at least one free end (not shown, see e.g., free end 210 of FIG. 2A) with an attached pull tab (not shown, see e.g., pull tab 208 of FIG. 2A).

The access panel is released from its nested position within a panel cavity (also not shown, see e.g., panel cavity 118 of FIG. 1) of the device chassis by pulling the filament out of and away from the device chassis. This action cuts an access line 325 in the textile covering 305 around a perimeter of the access panel. The access line 325 permits the access panel to be lifted out of the panel cavity and away from the device chassis to access the device component(s) for repair or replacement.

The access line 325 extends around an entire perimeter of the access panel, leaving no remainder connected to the device chassis. Thus, the living hinge of FIG. 3A is omitted from FIG. 3B and the access panel may be lifted entirely out of the panel cavity and separated from the device chassis to access the device component(s) for repair or replacement.

Following a repair or replacement of the device component(s), the access panel may be closed and secured in the post-cut state using secondary fasteners, such as double-sided tape strips 327, 329, 331, 333. As compared with FIG. 3A, additional double-sided tape strip 333 is in place of the living hinge. Other implementations may utilize greater or fewer double-sided tape strips so long as the access panel is adequately secured. Other secondary fasteners include magnets, other adhesives, or snaps that may be used similarly to secure the access panel in the post-cut state. While the access line 325 remains present and potentially visible in the post-cut state, it may be partially obscured by the clean cut provided by the scoring of the underside of the textile covering 305 (discussed below) and an obscuring pattern applied to the textile covering 305.

FIG. 4 illustrates a partial sectional view of an example detachable keyboard 400 having a filament cut hinged access panel 414 in a pre-cut state. The partial sectional view of FIG. 4 specifically shows a seam 434 between a device chassis 416 and the access panel 414. The keyboard 400 is covered with a textile covering 404 on a rear-facing surface (depicted at the top in FIG. 4) of the keyboard 100 and a textile covering 405 on a front-facing surface (depicted at the bottom in FIG. 4) of the keyboard 400. The textile coverings 404, 405 are adhered to the keyboard 400, specifically device chassis 416 and the access panel 414 using adhesive layers 436, 438, respectively. The adhesive layers 436, 438 may include pressure sensitive adhesive (PSA), heat activated film (HAF), or any other adhesive suitable for adhering the textile coverings 404, 405 to the device chassis 416 and the access panel 414.

In some implementations, PSA is technically advantageous over other adhesives for the adhesive layer 436 as the user can press the textile covering 404 back down onto the access panel 414 and the device chassis 416 when re-securing the access panel 414 in a post-cut state. The PSA may aid in holding the post-cut textile covering 404 in place as it remains sticky and is generally re-usable without any special considerations (e.g., heating). HAF may be similarly technically advantageous if the user is directed to apply heat (e.g., an iron) to the keyboard 400 when re-securing the access panel 414 in a post-cut state.

The textile coverings 404, 405 may further be laminated together using either or both of the adhesive layers 436, 438 at the edges of the keyboard 400, as shown at edge 440, to seal the device chassis 416 and the access panel 414 within the textile coverings 404, 405. One or both of the textile coverings 404, 405 may also be folded over one or more edges of the keyboard 400 in place of the depicted lamination. Further, a singular textile covering may be used, wrapping around the device chassis 416 and the access panel 414 and laminating to itself. The textile coverings also may cover less than an entirety of either or both of the rear-facing and front-facing surfaces of the keyboard 400. Any combination of the foregoing, or additional or different arrangements of textile coverings are contemplated herein so long as the at least the access panel 414 and an area surrounding the access panel 414, including the seam 434, are covered by one or more textile coverings.

The device chassis 416 serves as structure for the keyboard 400 and creates surfaces for mounting device components (not shown, see e.g., battery 106 of FIG. 1) within the keyboard 400. The device components may include a variety of components internal to the keyboard 400 that may require repair or replacement throughout the useable life of the keyboard 400. The access panel 414 is shown closed and secured in its pre-cut state in FIG. 4. The access panel 414 is nested within a panel cavity 418 of the device chassis 416. A gap cavity 442 runs about a perimeter of the access panel 414 between the access panel and the device chassis 416. The gap cavity 442 at least in part defines the seam 434 between the device chassis 416 and the access panel 414.

Further defining the seam 434 is an underside scoring 444 of the textile covering 404, which provides a weakened path about the textile covering 404 corresponding to the gap cavity 442. The scoring 444 is a cut or perforated area of the textile covering 404 that protrudes partially through the textile covering 404 from the underside of the textile covering 404 so that it is not visible from an exterior of the keyboard 400 in the depicted pre-cut state of the keyboard 400. A filament 412 extends from one end of the seam 434 to an opposing end of the seam 434 and is nested within the underside scoring 444 and the gap cavity 442. In other implementations, the filament 412 is nested within one of the underside scoring 444 and the gap cavity 442 exclusively. In other implementations, the underside scoring 444 is omitted and the filament 412 is intended to cut through an entirety of the thickness of the textile covering 404.

The access panel 414 is released from its depicted nested position within the panel cavity 418 of the device chassis 416 by pulling a tab (not shown, see e.g., tab 108 of FIG. 1) attached to a free end (also not shown, see e.g., free end 110 of FIG. 1) of the filament 412 out of and away from the device chassis 416. This action cuts an access line 424 (shown in dotted lines as it is not yet cut in the pre-cut state of FIG. 4) in the textile covering 404 around a perimeter of the access panel 414 at the seam 434. The underside scoring 444 is technically advantageous over the absence thereof in that it allows the filament 412 to create a clean and controlled access line 424 in the textile covering 404. The access line 424 permits the access panel 414 to be lifted out of the panel cavity 418 and away from the device chassis 416 to access the device component(s) for repair or replacement.

FIG. 5A illustrates a partial sectional view of an example detachable keyboard 500, specifically of a concealed seam living hinge 520 in an unfolded state. The living hinge 520 may be used for a hinged access panel, such as access panel 114 of FIG. 1, though other uses for the concealed seam living hinge 520 are contemplated herein. The various layers of the concealed seam living hinge 520 discussed below are not drawn to scale in FIGS. 5A-6 as the layers are particularly thin as compared to their covered surface area.

Conventional living hinge designs for fabric-covered panels often require costly manufacturing processes, such as laser-cut pivot patterns to create sufficiently flexible bending points. These processes increase production costs and can compromise the hinge's durability over a usable life of its corresponding computing device. Further, use of conventional hinges on fabric-covered access panels often create visible seams or parting lines when folded, which detract from the product's design and may leave marks after repeated use. Still further, conventional options for repair access frequently compromise the computing device's visual integrity, making it difficult to achieve a smooth, seamless reattachment after opening the access panel to conduct a repair or replacement of device components therein and replacing the access panel following the repair or replacement.

When used in conjunction with the also presently disclosed filament cut access panel, such as access panel 114 of FIG. 1, the presently disclosed living hinge 520 allows for access panel 514 to be pivoted out of its panel cavity and away from device chassis 516 at the living hinge 520 to access the device component(s) for repair or replacements. Following the repair or replacement, the access panel 514 may be closed and secured in a post-cut state.

The living hinge 520 further allows for a seamless appearance in the depicted unfolded state, particularly following the completed repair or replacement. In some implementations that adopt HAF as one or both of the first and second elastic adhesive layers 548, 550, discussed below, a user may apply heat (e.g., an iron) to the living hinge 520 to smooth any residual evidence of prior pivoting action of the living hinge 520.

The living hinge 520 is a flexible, multi-layered hinge that allows for up to an approximately 180-degree range of hinged motion, while maintaining an invisible seam after returning the living hinge 520 to an unfolded state, even after folding the living hinge 520 up to 180-degrees. The living hinge 520 is made up of a thin flexible film 546 (e.g., biaxially oriented polyethylene terephthalate (BoPET), often referred to as Mylar™) overlying a seam 534 between the device chassis 516 and the access panel 514. The thin flexible film 546 is particularly useful to hide the seam 534 from view. The thin flexible film 546 may also aid in preventing the textile covering 504 from bunching up when the living hinge 520 is folded. In various implementations, the thin flexible film 546 may be as thin as 10-150 micrometers (or microns).

The thin flexible film 546 is important for preventing the seam 534 from being visible from the exterior of the detachable keyboard 500 for at least the following reasons. First, BoPET (or a similar material) is a strong, flexible film that distributes mechanical stresses evenly across its surface. When the living hinge 520 bends, the thin flexible film 546 helps spread the bending forces uniformly, preventing concentrated stress points that could distort the textile covering 504 or cause a visible seam. Second, BoPET offers a favorable balance of flexibility and stiffness. While the thin flexible film 546 allows the living hinge 520 to bend smoothly, the thin flexible film 546 also maintains enough rigidity to prevent the textile covering 504 from deforming or creasing in a way that would create visible lines. Third, due to its excellent elasticity, BoPET returns to its original shape after being bent or folded. This helps the living hinge 520 to maintain a consistent profile during repeated use, preventing the formation of permanent lines or wear marks on the textile covering 504.

The thin flexible film 546 provides a smooth underlying surface for the textile covering 504 to attach to. This eliminates any irregularities or gaps in the underlying structure that could cause distortions in the textile covering 504. The thin flexible film 546 also acts as a buffer between the device chassis 516 and the access panel 514 and the textile covering 504 and prevents direct interaction between the textile covering 504 and the hinge's structural elements, reducing the chance of wear or damage that might result in visible seams. Further, the thin flexible film 546 enforces that bending occurs consistently along the whole living hinge 520, avoiding uneven folds that could lead to visible wear. The thin flexible film 546 creates a continuous structural layer beneath the textile covering 504, which conceals the seam 534 because the textile covering 504 does not directly interact with hard edges or gap between the device chassis 516 and the access panel 514. The thin flexible film 546 acts as a smooth, flexible bridge between the two pieces, ensuring that the textile covering 504 remains taut and seamless when the living hinge 520 moves.

The first elastic adhesive layer 548 adheres the thin flexible film 546 to the device chassis 516 and the access panel 514. The second elastic adhesive layer 550 adheres a textile covering 504 to the thin flexible film 546. The first and second elastic adhesive layers 548, 550 may include pressure sensitive adhesive (PSA), heat activated film (HAF), or any other adhesive suitable for adhering the textile covering 504 to the thin flexible film 546, and the thin flexible film 546 to the device chassis 516 and the access panel 514. A combination of the layers 504, 546, 548, 550, making up the living hinge 520 may be as thin as 500-1000 micrometers (or microns).

The extreme thinness of the living hinge 520, combined with a resilient flexibility of the layers 504, 546, 548, 550, and a limited duty cycle as the access panel 514 may only be access several times (or less) throughout the useable life of the detachable keyboard 500 yields the aforementioned performance characteristics of the living hinge 520, in particular its ability to conceal the seam 534 from a user. Further lending to the concealed characteristic is that the seam 534 need only be concealed from an exterior of the detachable keyboard 500. The seam 534 may be readily visible from inside the detachable keyboard 500, and the device chassis 516 and the access panel 514 may move significantly away from one another as the living hinge 520 is folded, as shown in FIGS. 5B and 6 and described below.

FIG. 5B illustrates a partial sectional view of the example detachable keyboard 500 of FIG. 5A, specifically of the concealed seam living hinge 520 in a partially folded state. When used in conjunction with the also presently disclosed filament cut access panel, such as access panel 114 of FIG. 1, the living hinge 520 allows for access panel 514 to be pivoted out of its panel cavity and away from device chassis 516 at the living hinge 520 to access the device component(s) for repair or replacements, as shown in FIG. 5B.

The depicted pivoting action allows the access panel 514 to pivot away from the device chassis 516, while still being connected together via the living hinge 520. As the living hinge 520 is made up of a thin flexible film 546 and a textile covering 504 adhered together and to the access panel 514 and the device chassis 516 via the first and second elastic adhesive layers 548, 550, the layers 504, 546, 548, 550 tend to stretch and compress as needed to accommodate the folding action of the living hinge 520. Specifically, outer layers 546, 548 of the living hinge 520 may tend to stretch as the inner layers 504, 550 of the living hinge 520 may tend to compress as the living hinge 520 is actuated, as shown. The device chassis 516 and the access panel 514 may move significantly away from one another as the living hinge 520 is folded, as shown. The partially folded state of FIG. 5B is illustrative of any partially folded state between 0-degrees and 180-degrees.

FIG. 6 illustrates a partial sectional view of the example detachable keyboard 500 of FIG. 5A, specifically of the concealed seam living hinge 520 in a folded over state. When used in conjunction with the also presently disclosed filament cut access panel, such as access panel 114 of FIG. 1, the living hinge 520 allows for access panel 514 to be pivoted out of its panel cavity and away from device chassis 516 at the living hinge 520, and even overly the device chassis 516 as shown, to access the device component(s) for repair or replacements, as shown in FIG. 6.

The depicted pivoting action allows the access panel 514 to pivot away from the device chassis 516, while still being connected together via the living hinge 520. As the living hinge 520 is made up of a thin flexible film 546 and a textile covering 504 adhered together and to the access panel 514 and the device chassis 516 via the first and second elastic adhesive layers 548, 550, the layers 504, 546, 548, 550 tend to stretch and compress as needed to accommodate the folding action of the living hinge 520. Specifically, outer layers 546, 548 of the living hinge 520 may tend to stretch as the inner layers 504, 550 of the living hinge 520 may tend to compress as the living hinge 520 is actuated, as shown. The device chassis 516 and the access panel 514 may move significantly away from one another and an accommodating gap 552 between the sections of the thin flexible film 546 may open as the living hinge 520 is folded, as shown.

The folded over state of FIG. 6 is illustrative of a maximum extent of hinged motion, at approximately 180-degrees. The living hinge 520 may further adopt secondary fasteners (see e.g., double-sided tape strips 326, 328, 330 of FIG. 3A) as mechanisms to hold the living hinge 520 open in the folded over state of FIG. 6 or closed in the unfolded state of FIG. 5A. The secondary fasteners may be as described above with reference to FIG. 3A, for example.

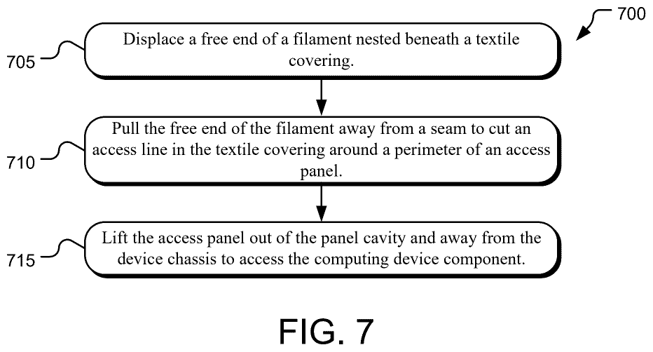

FIG. 7 illustrates example operations 700 for using a filament cut access panel to gain access to an interior of a computing device for device component repair or replacement. A textile covering overlies a seam between a device chassis and the access panel and the textile covering is adhered to a device chassis and the access panel. The access panel is nested within a panel cavity of the device chassis. A filament is nested between the device chassis and the access panel and extends around a perimeter of the access panel.

A displacing operation 705 displaces a free end of a filament nested beneath the textile covering. The displacing operation 705 may involve using a small tool to pry the free end of a filament, which may include a pull tab from beneath the textile covering.

A pulling operation 710 pulls the free end of the filament away from the seam to cut an access line in the textile around the perimeter of the access panel. The access line corresponds to a seam between the device chassis and the access panel.

A lifting operation 715 lifts the access panel out of the panel cavity and away from the device chassis to access the device component. The lifting operation 715 may include pivoting the access panel away from the device chassis at a living hinge, if present.

The presently disclosed technology includes living hinges that are folded and subsequently unfolded without visible evidence of the previous fold. Such living hinges may include a thin flexible film overlying the seam between the device chassis and the access panel, a first elastic adhesive layer adhering the thin flexible film to the device chassis and the access panel, and a second elastic adhesive layer adhering the textile covering to the thin flexible film. In an unfolded state, either prior or subsequent to folding the living hinge, the seam between the device chassis and the access panel is concealed.

The logical operations making up the embodiments of the invention described herein may be referred to variously as operations, steps, objects, or modules and may be performed in any order, adding or omitting operations as desired, unless explicitly claimed otherwise or a specific order is inherently necessitated by the claim language.

Implementations described herein include a computing device comprising a device chassis containing a device component, an access panel nested within a panel cavity of the device chassis, a textile covering adhered to the device chassis and the access panel and overlying a seam between the device chassis and the access panel, and a filament nested beneath the textile covering at the seam between the device chassis and the access panel. The filament extends around a perimeter of the access panel. The filament includes a free end to be pulled away from the seam to cut an access line in the textile covering around the perimeter of the access panel. The access line permits the access panel to be lifted out of the panel cavity and away from the device chassis to access the device component.

The textile covering may be scored on its underside around the perimeter of the access panel.

The filament may be further nested within the score in the textile covering.

A gap cavity may define the seam between the device chassis and the access panel. The filament may be further nested within the gap cavity.

The filament may further include a fixed end attached to the device chassis.

The the free end of the filament may include a pull tab.

The pull tab may be concealed beneath the textile covering.

The device component may be mounted to one of the device chassis and the access panel.

The computing device may further comprise a secondary fastener to secure the access panel within the panel cavity once the access line is cut.

The filament may extend around an entire perimeter of the access panel. The access line may permit the access panel to be separated from the device chassis to access the device component.

The filament may extend around a partial perimeter of the access panel. The access line may permit the access panel to be pivoted away from the device chassis to access the device component.

The access panel may be connected to the device chassis around a remaining perimeter of the access panel with a living hinge.

The living hinge may include a thin flexible film further overlying the seam between the device chassis and the access panel, a first elastic adhesive layer adhering the thin flexible film to the device chassis and the access panel, and a second elastic adhesive layer adhering the textile covering to the thin flexible film. In an unfolded state, the seam between the device chassis and the access panel may be concealed.

The thin flexible film may be a biaxially oriented polymer film and each of the first and the second elastic adhesive layers may be one of a pressure sensitive adhesive and a heat activated film.

The thin flexible film may be 10-150 micrometers thick.

The living hinge may allow for an approximately 180-degree range of hinged motion.

Implementations described herein further include a method of using a filament cut access panel to gain access to a device component within a computing device. The method comprises displacing a free end of a filament nested beneath a textile covering adhered to a device chassis containing the device component and an access panel nested within a panel cavity of the device chassis. The filament is further nested between the device chassis and the access panel. The textile covering overlies a seam between the device chassis and the access panel. The filament extends around a perimeter of the access panel. The method further comprises pulling the free end of the filament away from the seam to cut an access line in the textile covering around the perimeter of the access panel, and lifting the access panel out of the panel cavity and away from the device chassis to access the device component.

Lifting the access panel out of the panel cavity may include pivoting the access panel away from the device chassis at a living hinge. The living hinge may include a thin flexible film further overlying the seam between the device chassis and the access panel, a first elastic adhesive layer adhering the thin flexible film to the device chassis and the access panel, and a second elastic adhesive layer adhering the textile covering to the thin flexible film, wherein in an unfolded state, the seam between the device chassis and the access panel is concealed.

Implementations described herein further include a detachable keyboard comprising a device chassis containing a battery, an access panel nested within a panel cavity of the device chassis, a textile covering adhered to the device chassis and the access panel and overlying a seam between the device chassis and the access panel, and a filament nested beneath the textile covering at the seam between the device chassis and the access panel. The filament extends around a partial perimeter of the access panel. The filament includes a free end to be pulled away from the seam to cut an access line in the textile covering around the partial perimeter of the access panel. The access line permits the access panel to be lifted out of the panel cavity and pivoted away from the device chassis to remove and replace the battery.

The access panel may be connected to the device chassis around a remaining perimeter of the access panel with a living hinge. The living hinge may include a thin flexible film further overlying the seam between the device chassis and the access panel, a first elastic adhesive layer adhering the thin flexible film to the device chassis and the access panel, and a second elastic adhesive layer adhering the textile covering to the thin flexible film. In an unfolded state, the seam between the device chassis and the access panel may be concealed.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A computing device comprising:
a device chassis containing a device component;
an access panel nested within a panel cavity of the device chassis;
a textile covering adhered to the device chassis and the access panel and overlying a seam between the device chassis and the access panel; and
a filament nested beneath the textile covering at the seam between the device chassis and the access panel, the filament extending around a perimeter of the access panel, the filament including a free end to be pulled away from the seam to cut an access line in the textile covering around the perimeter of the access panel, the access line permitting the access panel to be lifted out of the panel cavity and away from the device chassis to access the device component.

2. The computing device of claim 1, wherein the textile covering is scored on its underside around the perimeter of the access panel.

3. The computing device of claim 2, wherein the filament is further nested within the score in the textile covering.

4. The computing device of claim 1, wherein a gap cavity defines the seam between the device chassis and the access panel, and wherein the filament is further nested within the gap cavity.

5. The computing device of claim 1, wherein the filament further includes a fixed end attached to the device chassis.

6. The computing device of claim 1, wherein the free end of the filament includes a pull tab.

7. The computing device of claim 6, wherein the pull tab is concealed beneath the textile covering.

8. The computing device of claim 1, wherein the device component is mounted to one of the device chassis and the access panel.

9. The computing device of claim 1, further comprising:
a secondary fastener to secure the access panel within the panel cavity once the access line is cut.

10. The computing device of claim 1, wherein the filament extends around an entire perimeter of the access panel, and wherein the access line permits the access panel to be separated from the device chassis to access the device component.

11. The computing device of claim 1, wherein the filament extends around a partial perimeter of the access panel, and wherein the access line permits the access panel to be pivoted away from the device chassis to access the device component.

12. The computing device of claim 11, wherein the access panel is connected to the device chassis around a remaining perimeter of the access panel with a living hinge.

13. The computing device of claim 12, wherein the living hinge includes:
a thin flexible film further overlying the seam between the device chassis and the access panel;
a first elastic adhesive layer adhering the thin flexible film to the device chassis and the access panel; and
a second elastic adhesive layer adhering the textile covering to the thin flexible film, wherein in an unfolded state, the seam between the device chassis and the access panel is concealed.

14. The computing device of claim 13, wherein the thin flexible film is a biaxially oriented polymer film and each of the first and the second elastic adhesive layers are one of a pressure sensitive adhesive and a heat activated film.

15. The computing device of claim 13, wherein the thin flexible film is 10-150 micrometers thick.

16. The computing device of claim 13, wherein the living hinge allows for an approximately 180-degree range of hinged motion.

17. A method of using a filament cut access panel to gain access to a device component within a computing device, the method comprising:
displacing a free end of a filament nested beneath a textile covering adhered to a device chassis containing the device component and an access panel nested within a panel cavity of the device chassis, the filament further nested between the device chassis and the access panel, the textile covering overlying a seam between the device chassis and the access panel, the filament extending around a perimeter of the access panel;
pulling the free end of the filament away from the seam to cut an access line in the textile covering around the perimeter of the access panel; and
lifting the access panel out of the panel cavity and away from the device chassis to access the device component.

18. The method of claim 17, wherein lifting the access panel out of the panel cavity includes pivoting the access panel away from the device chassis at a living hinge, wherein the living hinge includes:
a thin flexible film further overlying the seam between the device chassis and the access panel;
a first elastic adhesive layer adhering the thin flexible film to the device chassis and the access panel; and
a second elastic adhesive layer adhering the textile covering to the thin flexible film, wherein in an unfolded state, the seam between the device chassis and the access panel is concealed.

19. A detachable keyboard comprising:
a device chassis containing a battery;
an access panel nested within a panel cavity of the device chassis;
a textile covering adhered to the device chassis and the access panel and overlying a seam between the device chassis and the access panel; and
a filament nested beneath the textile covering at the seam between the device chassis and the access panel, the filament extending around a partial perimeter of the access panel, the filament including a free end to be pulled away from the seam to cut an access line in the textile covering around the partial perimeter of the access panel, the access line permitting the access panel to be lifted out of the panel cavity and pivoted away from the device chassis to remove and replace the battery.

20. The detachable keyboard of claim 19, wherein the access panel is connected to the device chassis around a remaining perimeter of the access panel with a living hinge, wherein the living hinge includes:
a thin flexible film further overlying the seam between the device chassis and the access panel;
a first elastic adhesive layer adhering the thin flexible film to the device chassis and the access panel; and
a second elastic adhesive layer adhering the textile covering to the thin flexible film, wherein in an unfolded state, the seam between the device chassis and the access panel is concealed.
